(19) United States
(12) Patent Application Publication
(10) Pub. No.: US 2012/0216991 A1
(43) Pub. Date: Aug. 30, 2012

(54) METHOD FOR ASSEMBLING HEAT PIPE AND THERMO-CONDUCTIVE BODY AND STRUCTURE THEREOF

(76) Inventor: Shih-Ming CHEN, New Taipei City (TW)

(21) Appl. No.: 13/034,745

(22) Filed: Feb. 25, 2011

(51) Int. Cl. F28D 15/02; B23P 19/04

(52) U.S. Cl. 165/104.21; 29/890.032

(57) ABSTRACT

A heat pipe and thermo-conductive body assembling structure and a method for manufacturing the same are disclosed. The thermo-conductive body is provided a trough with two pressing arms at the opening thereof. The heat pipe is accommodated in the trough and pressed by the pressing arms. An exposed portion of the heat pipe and outer surfaces of the pressing arms are coplanar.

### BACKGROUND OF THE INVENTION

1. Technical Field

The invention relates to heat sinks, particularly to heat sinks with heat pipes.

2. Related Art

A cooler including a heat pipe possesses great capacibility to dissipate a large amount of heat generated by a central processing unit. Coolers with heat pipes is progrssively replacing coolers without heat pipes. However, the assembly of a heat pipe and a thermo-conductive body is still a problem to be solved.

Traditionally, a thermo-conductive body is provided with a trough for accommodating a heat pipe. However, the thermo-conductive body and heat pipe will get loose after frequent thermal expansion because the different coefficient of thermal expansion. On the other hand, the hollow heat pipe cannot have good anti-deformation ability, so the heat pipe is easy to escape from the trough when assembling the heat pipe in the trough.

### SUMMARY OF THE INVENTION

A primary object of the invention is to provide a method and structure of assembling a heat pipe and a thermo-conductive body, which can make the heat pipe firmly held in the trough of the thermo-conductive body.

A secondary object of the invention is to provide a method and structure of assembling a heat pipe and a thermo-conductive body, which can make a coplanar surface composed of the pressing arms, heat pipe and thermo-conductive body for directly attaching a heat source.

To accomplish the above objects, the heat pipe and thermo-conductive body assembling structure of the invention includes a heat pipe and a thermo-conductive body. The thermo-conductive body is provided a trough with two pressing arms at the opening thereof The heat pipe is accommodated in the trough and pressed by the pressing arms. An exposed portion of the heat pipe and outer surfaces of the pressing arms are coplanar.

To accomplish the above objects, the method for assembling a heat pipe and a thermo-conductive body includes the steps of:
a) providing a thermo-conductive body having a trough with two pressing arms at an opening thereof;
b) providing a heat pipe and putting the heat pipe in the trough; and
c) flatening the pressing arms and the heat pipe to make them coplanar.

### BRIEF DESCRIPTION OF THE DRAWINGS

FIG. 1 is a flowchart of the method of the invention;

FIGS. 2A-2C are cross-sectional views of the first embodiment of the invention;

FIGS. 3A-3C are cross-sectional views of the second embodiment of the invention;

FIGS. 4A-4C are cross-sectional views of the third embodiment of the invention; and

FIGS. 5A-5C are cross-sectional views of the fourth embodiment of the invention;

### DETAILED DESCRIPTION OF THE INVENTION

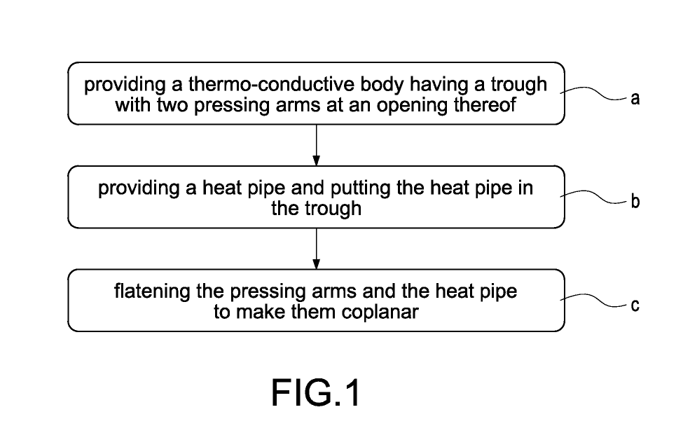

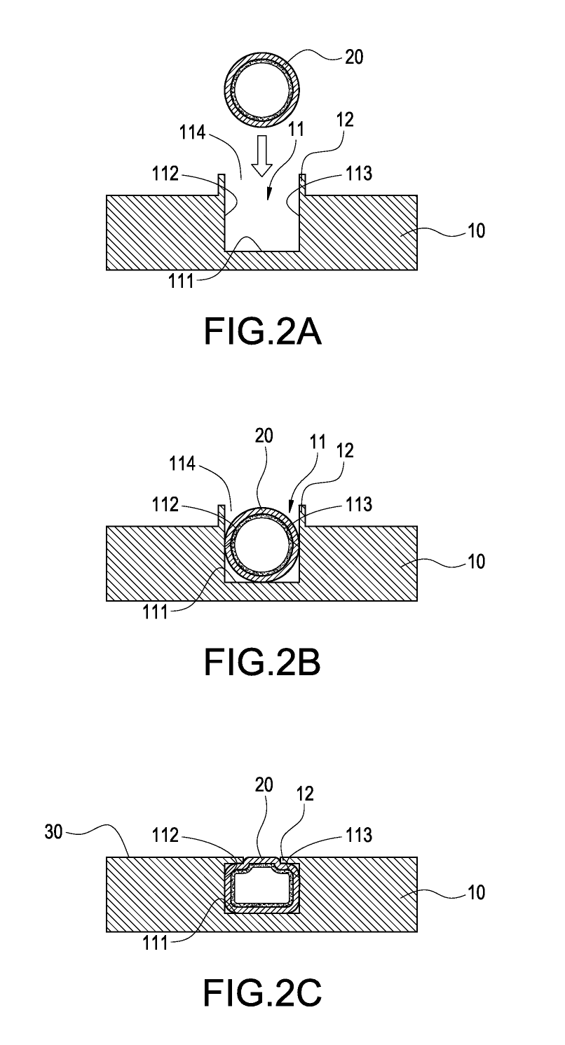

Please refer to FIGS. 1 and 2A-2C. The method for assembling a heat pipe and a thermo-conductive body includes the steps of:
a) Providing a thermo-conductive body 10 having a trough 11 with two pressing arms 12 at an opening 114 thereof Referring to FIG. 2A, the thermo-conductive body 10 is made of copper, aluminum or alloy thereof. And the thermo-conductive body 10 is a cuboid. The trough 11 includes a flat bottom 111, two vertical sides 112, 113 perpendicular to the flat bottom 111 and an opening 114. Each of the pressing arms 12 has a rectangular cross-section and extends from the two vertical sides 112,113.
b) Providing a heat pipe 20 and putting the heat pipe 20 in the trough 11. Referring to FIG. 2B, the heat pipe 20 may be a cylindrical tube and includes a wick structure formed by sintered powder or woven mesh and a working fluid, and
c) Flatening the pressing arms 12 and the heat pipe 20 to make them coplanar. The pressing arms 12 are bent by a press machine (not shown) to press and clamp the heat pipe 20 and to make a coplanar surface 30. Please refer to FIG. 2C. The heat pipe 20 is deformed into the shapes of the flat bottom 111 and the vertical sides 112, 113 of the trough 11. The exposed portion of the heat pipe 20 is pressed to be coplanar to the pressing arms 12.

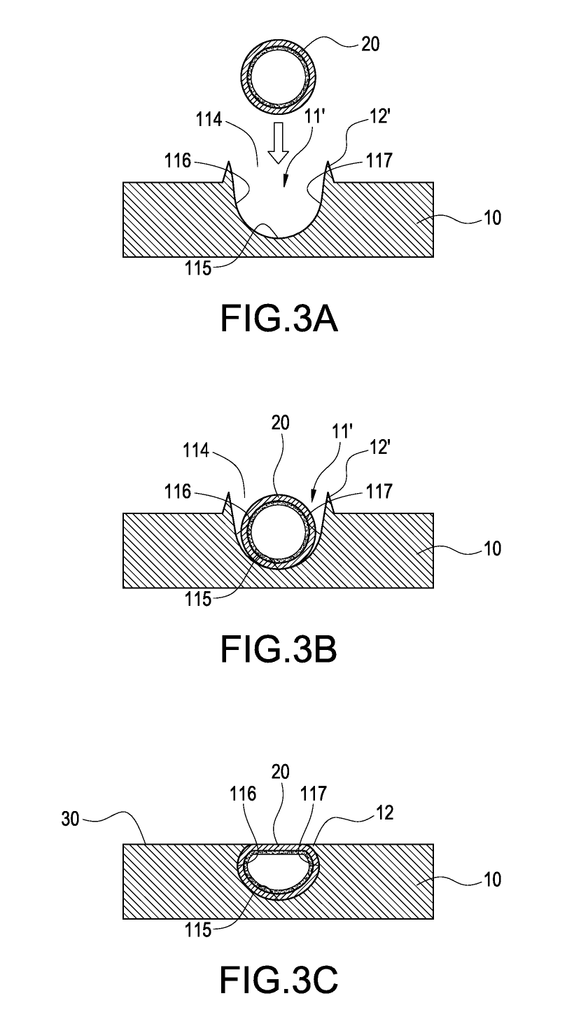

Please refer to FIGS. 3A-3C. The trough 11′ may be composed of a curved bottom 115, two slant sides 116, 117 and an opening 114. And each of the pressing arms 12′ has a triangular cross-section.

Similarly, the heat pipe 20 is put in the trough 11′ first. The pressing arms 12′ are pressed and flattened. The heat pipe 20 is deformed to be in accordance with the shape of the curved bottom 115 and slant sides 116, 117. The exposed portion of the heat pipe 20 is pressed to be coplanar to the pressing arms 12′. Thus a coplanar surface 30 is obtained.

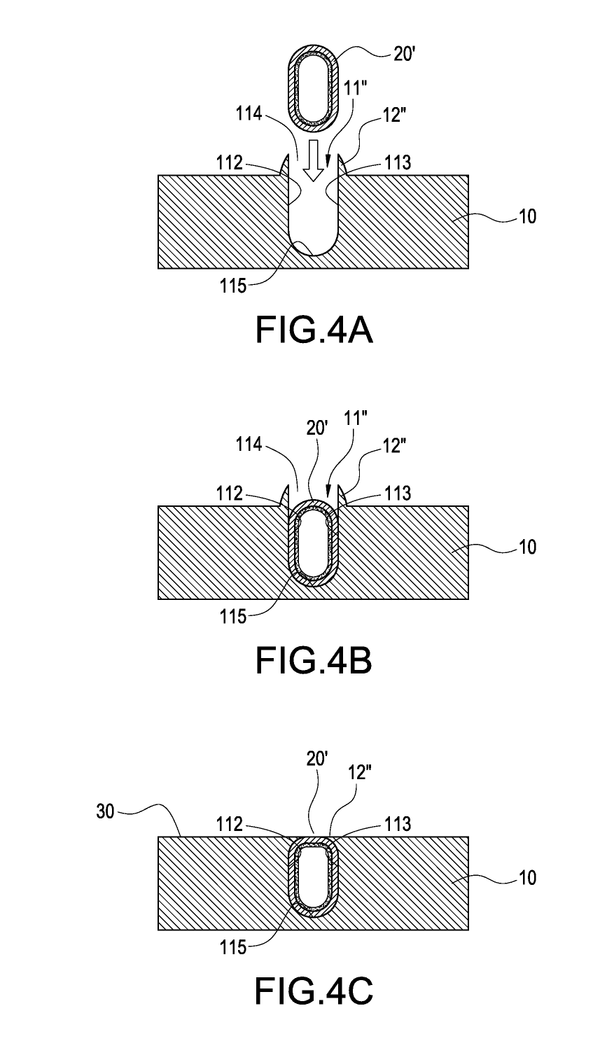

Please refer to FIGS. 4A-4C. The trough 11″ may be composed of a curved bottom 115, two vertical sides 112, 113 and an opening 114. And each of the pressing arms 12″ has a knifeedged cross-section. The heat pipe 20′ is of a flattened shape.

Similarly, the heat pipe 20′ is put in the trough 11″ first. The pressing arms 12″ are pressed and flattened. The heat pipe 20′ is deformed to be in accordance with the shape of the curved bottom 115 and vertical sides 112, 113. The exposed portion of the heat pipe 20′ is pressed to be coplanar to the pressing arms 12″. Thus a coplanar surface 30 is obtained.

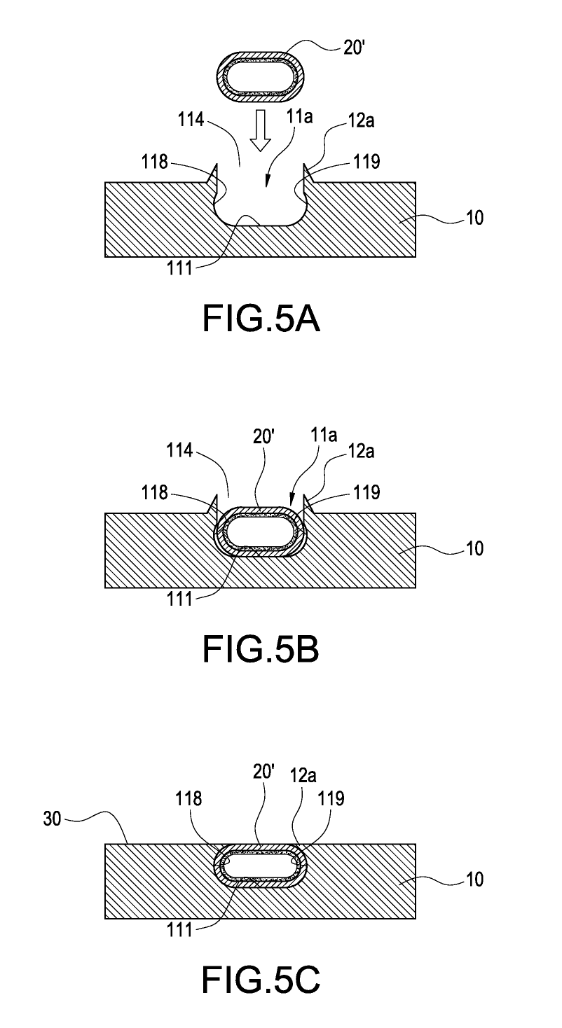

Please refer to FIGS. 5A-5C. The trough 11a may be composed of a flat bottom 111, two curved sides 118, 119 and an opening 114. And each of the pressing arms 12a has a triangular cross-section. The heat pipe 20′ is of a flattened shape.

Similarly, the heat pipe 20′ is put in the trough 11a first. The pressing arms 12a are pressed and flattened. The heat pipe 20′ is deformed to be in accordance with the shape of the flat bottom 111 and curved sides 118, 119. The exposed portion of the heat pipe 20′ is pressed to be coplanar to the pressing arms 12a. Thus a coplanar surface 30 is obtained.

It will be appreciated by persons skilled in the art that the above embodiments have been described by way of example only and not in any limitative sense, and that various alterations and modifications are possible without departure from the scope of the invention as defined by the appended claims.

What is claimed is:

1. An assembly of heat sink, comprising:
a thermo-conductive body, provided with a trough, and an opening of the trough being formed with two pressing arms; and
a heat pipe, accommodated in the trough and pressed by the pressing arms;
wherein an exposed portion of the heat pipe and outer surfaces of the pressing arms are coplanar.

2. The assembly of heat sink of claim 1, wherein the trough is composed of a flat bottom, two vertical sides and an opening, the heat pipe is deformed to be in accordance with shapes of the flat bottom and the vertical sides.

3. The assembly of heat sink of claim 2, wherein the pressing arms extend from the thermo-conductive body and each of the pressing arms has a rectangular cross-section.

4. The assembly of heat sink of claim 1, wherein the trough is composed of a curved bottom, two slant sides and an opening, the heat pipe is deformed to be in accordance with shapes of the curved bottom and the slant sides.

5. The assembly of heat sink of claim 4, wherein the pressing arms extend from the thermo-conductive body and each of the pressing arms has a triangular cross-section.

6. The assembly of heat sink of claim 1, wherein the trough is composed of a curved bottom, two vertical sides and an opening, the heat pipe is deformed to be in accordance with shapes of the curved bottom and the vertical sides.

7. The assembly of heat sink of claim 6, wherein the pressing arms extend from the thermo-conductive body and each of the pressing arms has a knifeedged cross-section.

8. The assembly of heat sink of claim 1, wherein the trough is composed of a flat bottom, two curved sides and an opening, the heat pipe is deformed to be in accordance with shapes of the flat bottom and the curved sides.

9. The assembly of heat sink of claim 1, wherein each of the pressing arms is a sheet.

10. The assembly of heat sink of claim 1, wherein the thermo-conductive body is a cuboid.

11. The assembly of heat sink of claim 1, wherein the thermo-conductive body is made of copper or aluminum.

12. A method for assembling a heat sink, comprising the steps of:
a) providing a thermo-conductive body having a trough with two pressing arms at an opening thereof;
b) providing a heat pipe and putting the heat pipe in the trough; and
c) flatening the pressing arms and the heat pipe to make them coplanar.

13. The method of claim 12, wherein the trough of step a) is composed of a flat bottom and two vertical sides.

14. The method of claim 13, wherein the heat pipe is deformed to be in accordance with shapes of the flat bottom and the vertical sides in step c).

15. The method of claim 12, wherein the trough of step a) is composed of a curved bottom and two slant sides.

16. The method of claim 15, wherein the heat pipe is deformed to be in accordance with shapes of the curved bottom and the slant sides in step c).

17. The method of claim 12, wherein the trough of step a) is composed of a curved bottom and two vertical sides.

18. The method of claim 17, wherein the heat pipe is deformed to be in accordance with shapes of the curved bottom and the vertical sides in step c).

19. The method of claim 12, wherein the trough of step a) is composed of a flat bottom and two curved sides.

20. The method of claim 19, wherein the heat pipe is deformed to be in accordance with shapes of the flat bottom and the curved sides in step c).
